(19) United States
(12) Patent Application Publication
(10) Pub. No.: US 2015/0369778 A1
(43) Pub. Date: Dec. 24, 2015

(54) CHEMICAL SENSOR ARRAY AND METHODS OF MAKING AND USING THE SAME

(71) Applicant: EMPIRE TECHNOLOGY DEVELOPMENT LLC, Wilmington, DE (US)

(72) Inventor: Yahuhisa Fujii, Kyoto-shi, Kyoto (JP)

(21) Appl. No.: 14/765,532

(22) PCT Filed: Feb. 6, 2013
(86) PCT No.: PCT/US2013/024949

§ 371 Date: Aug. 3, 2015

(51) Int. Cl. G01N 29/02; G01N 29/44

(52) U.S. Cl. CPC G01N 29/02; G01N 29/44; G01N 2291/021; G01N 2291/106

(57) ABSTRACT

Chemicals sensor arrays are disclosed for detecting analytes in a sample. The chemical sensor array may include two or more vibration detection units. In some embodiments, the vibration detection units each independently include: a piezoelectric element having a first side and a second side; a first electrode disposed on the first side of the piezoelectric element; a second electrode disposed on the first side of the piezoelectric element, wherein the second electrode is spaced apart from the first electrode; and a conductive layer disposed on the piezoelectric element. The conductive layer is spaced apart from the first electrode and the second electrode. Methods of making and using the chemical sensor array are also disclosed.

### BACKGROUND

Chemical sensors refer to devices that convert chemical quantities into electrical signals. Chemical sensors record the concentration of atoms, molecules, ions, etc. in gas or liquid by using electrical signals. There are a variety of potential applications for chemical sensors, including environmental chemical monitoring, industrial process control, leakage tests, automobile discharge tests, and healthcare.

### SUMMARY

Some embodiments disclosed herein include a chemical sensor array. In some embodiments, the chemical sensor array includes two or more vibration detection units fixed to a substrate. The vibration detection units each independently include: a piezoelectric element having a first side and a second side; a first electrode disposed on the first side of the piezoelectric element; a second electrode disposed on the first side of the piezoelectric element, wherein the second electrode is spaced apart from the first electrode; and a conductive layer disposed on the piezoelectric element, wherein the conductive layer is spaced apart from the first electrode and the second electrode.

Some embodiments disclosed herein include a method for sensing one or more analytes in a sample. The method can include providing a chemical sensor array. The chemical sensor array can include two or more vibration detection units. The two or more vibration detection units can include a piezoelectric element having a first side and a second side; a first electrode disposed on the first side of the piezoelectric element; a second electrode disposed on the first side of the piezoelectric element, wherein the second electrode is spaced apart from the first electrode; and a conductive layer disposed on the piezoelectric element, wherein the conductive layer is spaced apart from the first electrode and the second electrode. The method can further include: contacting the sample with at least one of the conductive layers in the vibration detection units; applying a voltage between the first electrode and the second electrode in each of the vibration detection units; and receiving oscillating electrical signals from one or more of the vibration detection units using the first electrode and the second electrode.

Some embodiments disclosed herein include a method for making a chemical sensor array, the method including: forming two or more elevated regions on a first side of a piezoelectric substrate; forming first electrodes on each of the elevated regions; forming second electrodes on each of the elevated regions; and forming conductive layers on a second side of the piezoelectric substrate, wherein each of the conductive layers are laterally aligned with one of the elevated regions.

Some embodiments disclosed herein include a system for sensing an analyte in a sample. The system can include: a chemical sensor array comprising two or more vibration detection units, wherein the vibration detection units each include: a piezoelectric element having a first side and a second side; a first electrode disposed on the first side of the piezoelectric element; a second electrode disposed on the first side of the piezoelectric element, wherein the second electrode is spaced apart from the first electrode; and a conductive layer disposed on the piezoelectric element, wherein the conductive layer is spaced apart from the first electrode and the second electrode; one or more voltage sources electrically coupled to the first electrode and the second electrode in each of the vibration detection units; one or more data acquisition units electrically coupled to the first electrode and the second electrode in the vibration detection units, wherein the data acquisition units are configured to receive oscillatory signals from the first electrode and the second electrode; and a processor configured to receive a signal representing the oscillator signals from the data acquisition units, wherein the processor is further configured to determine a frequency for the oscillator signals.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1A shows a bottom view of chemical sensory array 100, which is within the scope of the present application.

FIG. 1B is a top view of chemical sensory array 100, which is within the scope of the present application.

FIG. 1C is a cross-sectional view of chemical sensor array 100, which is within the scope of the present application.

FIG. 2A shows a bottom view of a piezoelectric element having a cylindrical structure that is within the scope of the present application.

FIG. 2B shows a cross-sectional view a piezoelectric element having a cylindrical structure that is within the scope of the present application.

FIG. 3A shows a bottom view of a piezoelectric element having a trapezoidal structure that is within the scope of the present application.

FIG. 3B shows a cross-sectional view a piezoelectric element having a trapezoidal structure that is within the scope of the present application.

FIG. 4A shows one example a vibration detection unit including semi-circular electrode pairs that is within the scope of the present application.

FIG. 4B shows one example a vibration detection unit including polygonal electrode pairs that is within the scope of the present application.

FIG. 5 is a flow diagram illustrating an example method for sensing one or more analytes in a sample that is within the scope of the present application.

FIG. 6 is a flow diagram illustrating an example method for making a chemical sensor array that is within the scope of the present application.

FIG. 7 shows the change in frequency for the chemical sensors in Example 3 having a pair of electrodes on the same side of the piezoelectric element after exposure to 25 ppm of ammonia.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

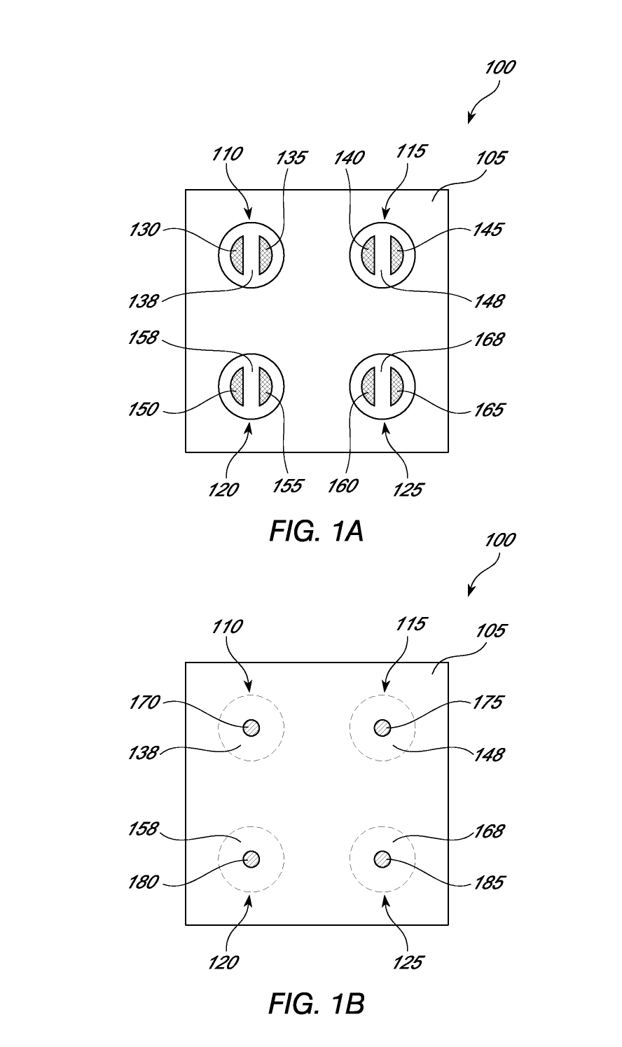

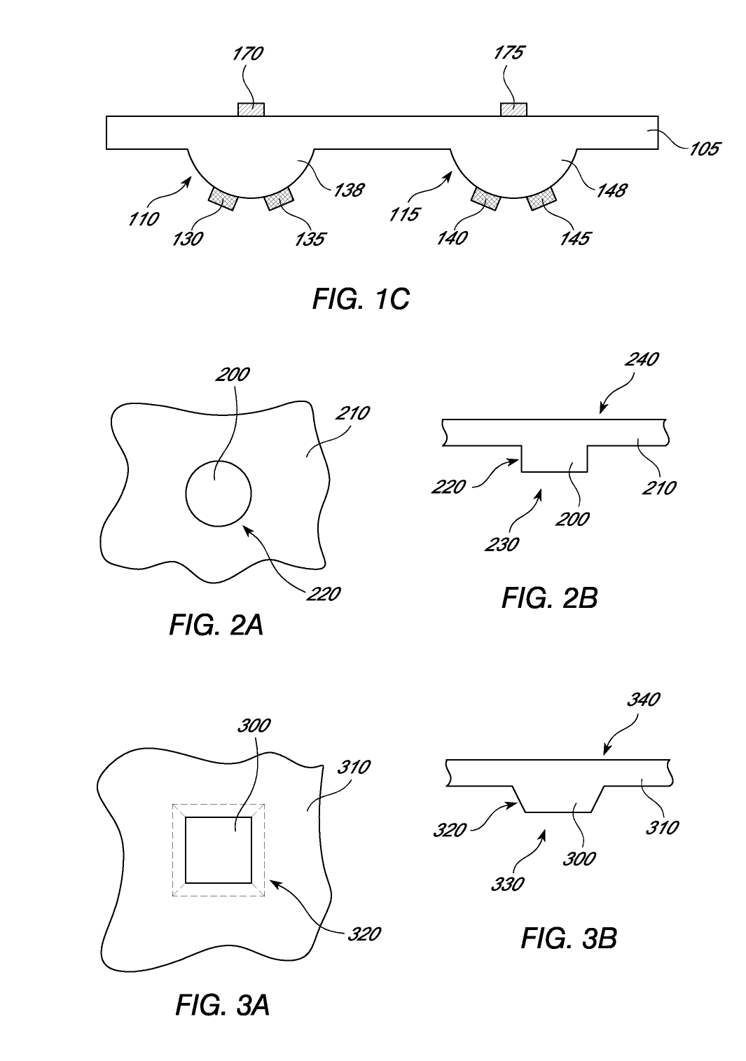

Some embodiments disclosed herein include a chemical sensor array. FIGS. 1A-C show one example of a chemical sensor array that is within the scope of the present application. FIG. 1A shows a bottom view of chemical sensory array 100, which includes substrate 105 and four vibration detection units disposed on substrate 105: vibration detection unit 110, vibration detection unit 115, vibration detection unit 120, and vibration detection unit 125. Each vibration detection unit includes a pair of electrodes spaced apart and disposed on the same side of a piezoelectric element. Vibration detection unit 110 includes first electrode 130 and second electrode 135 both disposed on the bottom side of piezoelectric element 138. Similarly, vibration detection unit 115 includes first election 140 and second electrode 145 disposed on piezoelectric element 148. Vibration detection unit 120 includes first election 150 and second electrode 155 disposed on piezoelectric element 158. Vibration detection unit 125 includes first election 160 and second electrode 165 disposed on piezoelectric element 168.

FIG. 1B is a top view of chemical sensory array 100. Each of the vibration detection units include a conductive layer on the top surface of the piezoelectric element. Vibration detection unit 110 includes conductive layer 170 disposed on the top side of piezoelectric element 138. Vibration detection unit 115 includes conductive layer 175 disposed on the top side of piezoelectric element 148. Vibration detection unit 120 includes conductive layer 180 disposed on the top side of piezoelectric element 158. Vibration detection unit 125 includes conductive layer 185 disposed on the top side of piezoelectric element 168.

FIG. 1C is a cross-sectional view of chemical sensor array 100. As shown, the bottom side of piezoelectric element 138 (where first electrode 130 and second electrode 135 are disposed) has a convex surface. The top side of piezoelectric element 138 (where conductive layer 170 is disposed) can have a generally planar surface. As shown, piezoelectric element 148 has generally the same configuration as piezoelectric element 138. Piezoelectric element 158 and piezoelectric element 168 may also have generally the same configuration as piezoelectric element 138 (not shown).

As will be discussed further below, the chemical sensor array (e.g., chemical sensor array 100 depicted in FIG. 1A-C) can be used to detect one or more analytes in composition that contacts at least a portion of the conductive layer. Oscillatory electrical signals between the electrode pairs can be received and correlated with an amount of analyte in the composition.

The chemical sensor array may advantageously have small dimensions. Thus, for example, the chemical sensor array may be incorporated in mobile devices, such as a cell phone or other hand-held electronics. The chemical sensor array may, for example, have a largest dimension of less than about 20 cm, less than about 10 cm, less than about 2 cm, or less than about 1 cm. As a non-limiting example, chemical sensor array 100 depicted in FIG. 1A-C may have dimensions of about 10 mm×10 mm×100 μm.

The shape and dimensions for the piezoelectric elements can be varied. For example, the piezoelectric element can have a convex surface on one side and a planar surface on a second side (e.g., as shown for piezoelectric element 138 depicted FIGS. 1A-C). The piezoelectric element, however, can have various other shapes, such as polygonal, rectangular, square, cylindrical, or trapezoidal. In some embodiments, each of the piezoelectric elements in the chemical sensor array have about the same shape and dimensions.

FIGS. 2A-B show one example of a piezoelectric element having a cylindrical shape that is within the scope of the present application. FIG. 2A shows a bottom view of piezoelectric element 200 on substrate 210 (additional components omitted for clarity). FIG. 2B is a cross-sectional view of piezoelectric element 200. Piezoelectric element 200 includes rounded surface 220, planar surface 230, and planar surface 240. A pair of electrode may be disposed on planar surface 230, while a conductive layer may be disposed on planar surface 240.

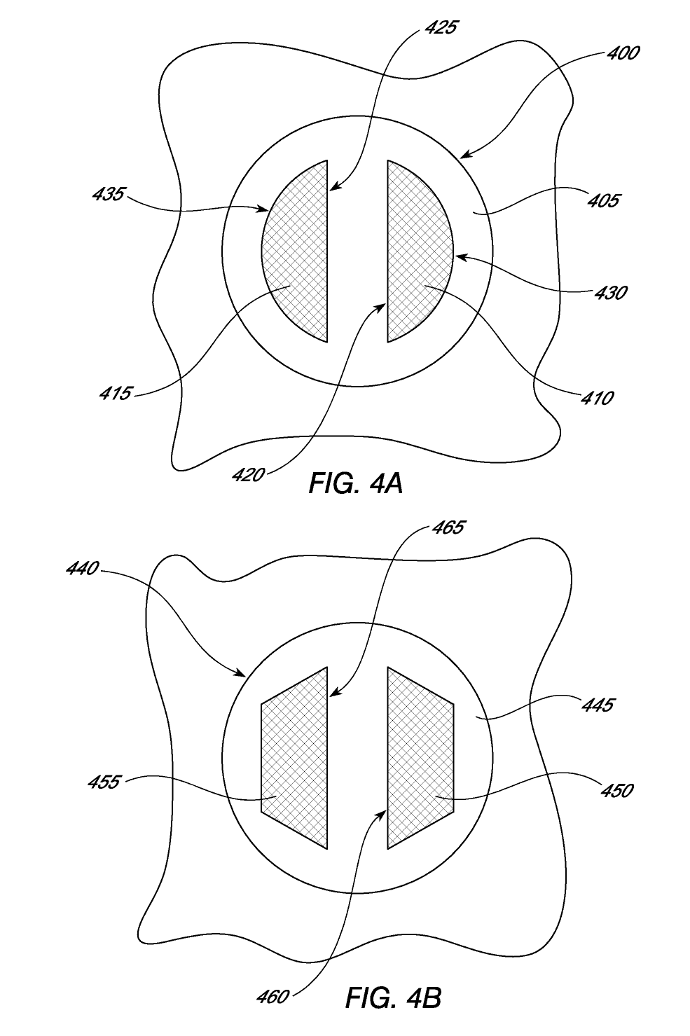

FIGS. 3A-B show one example of a piezoelectric element having a trapezoidal shape that is within the scope of the present application. FIG. 3A shows a bottom view of piezoelectric element 300 on substrate 310 (additional components omitted for clarity). FIG. 3B is a cross-sectional view of piezoelectric element 300. Piezoelectric element 300 includes beveled edge 320, planar surface 330, and planar surface 340. A pair of electrodes may be disposed on planar surface 330, while a conductive layer may be disposed on planar surface 340.

The thickness of the piezoelectric element is not particularly limited (e.g., the distance between planar surface 330 and planar surface 340 for piezoelectric element 300 depicted in FIG. 3B). The thickness can be, for example, at least about 0.1 μm, at least about 1 μm, at least about 10 μm, or at least about 100 μm. The thickness can be, for example, less than or equal to about 1 mm or less than or equal to about 500 μm. In some embodiments, the thickness of the piezoelectric element is about 0.1 μm to about 1 mm, or about 100 μm to about 500 μm.

The width of the piezoelectric element may also vary (e.g., the width of piezoelectric element 200 as depicted in FIGS. 2A-B is the diameter of rounded surface 220). The width can be, for example, at least about 100 μm, at least about 500 μm, at least about 1 mm, or at least about 2 mm. The width can be, for example, less than or equal to about 1 cm, less than or equal to about 5 mm, or less than or equal to about 3 mm. In some embodiments, the width of the piezoelectric element is about 100 μm to about 1 cm, or about 500 μm to about 5 mm.

The piezoelectric element may generally include (or consist of) any piezoelectric material. The piezoelectric material may have sufficient piezoelectric properties so that oscillatory electrical signals from the piezoelectric element can be used to detect a change in the vibrational resonance frequency of the piezoelectric element. In some embodiments, the piezoelectric element includes a ceramic. Non-limiting examples of suitable piezoelectric materials include lithium niobate, potassium niobate, lead zirconate titanate, barium titanate, langasite, and quartz. In some embodiments, the piezoelectric element is a single crystal ceramic (e.g., a single crystal of quartz). In some embodiments, the piezoelectric element includes (or consists of) quartz. In some embodiments, the piezoelectric element includes (or consists of) AT-cut quartz.

The electrode pairs in each of the vibrate detection units (e.g., first electrode 130 and second electrode 135 of vibration detection unit 110 as depicted in FIGS. 1A-C) can have various configurations. Each electrode on the piezoelectric element may, for example, have a semi-ellipsoidal, semi-circular, or polygonal shape.

FIG. 4A shows one example a vibration detection unit including semi-circular electrode pairs. Vibration detection unit 400 includes first electrode 410 and second electrode 415 disposed on piezoelectric element 405. First electrode 410 includes linear edge 420 and rounded edge 430 that together form a semi-circular surface. Similarly, second electrode 415 includes linear edge 425 and rounded edge 435 that together form a semi-circular surface. Linear edge 420 of first electrode 410 can be generally parallel and facing linear edge 425 of second electrode 415.

FIG. 4B shows one example a vibration detection unit including polygonal electrode pairs. Vibration detection unit 440 includes first electrode 450 and second electrode 455 disposed on piezoelectric element 445. First electrode 450 has a trapezoidal surface that includes linear edge 460, while second electrode 455 also has a trapezoidal surface that includes linear edge 465. Linear edge 460 of first electrode 450 can be generally parallel and facing linear edge 465 of second electrode 455. The skilled artisan, guided by the teachings of the present application, will appreciate that various other shapes are possible, such a square, rectangle, pentagon, and the like.

The electrode pair on each vibration detection unit may have the same or different shape and/or dimensions. For example, two electrodes on the surface of the same piezoelectric element may both be a square with the same dimensions. As another example, one electrode on a piezoelectric element can be a square, while a second electrode on the same piezoelectric element can be a rectangle. In some embodiments, each of the electrodes in the chemical sensory array has about the same shape and dimensions.

The distance between the pair of electrodes on each vibration detection unit may vary. In some embodiments, the distance between the pair of electrodes (e.g., the distance between linear edge 420 of first electrode 410 and linear edge 425 of second electrode 415 as depicted in FIG. 4A) is about 1 to about 3 times the thickness of the piezoelectric element. In some embodiments, the distance between the pair of electrodes is about 30 μm to about 1.5 mm. In some embodiments, the distance between the pair of electrodes is about 80 μm to about 400 μm.

The surface area of the pair of electrodes is not particularly limited. Generally, the surface area of the electrodes may be sufficient to receive an oscillatory electrical signal corresponding to a vibrational resonance frequency of the piezoelectric element. In some embodiments, each electrode covers at least about 25% of the bottom surface of the piezoelectric element. Each electrode may, for example, have a largest dimension of at least about 25 μm, at least about 100 μm, at least about 250 μm, at least about 500 μm, at least about 1 mm. Each electrode may, for example, have a largest dimension of less than or equal to about 5 mm, less than or equal to about 2 mm, or less than or equal to about 1 mm. In some embodiments, each electrode has a largest dimension of about 25 μm to about 5 mm, or about 100 μm to about 5 mm. In some embodiments, the each electrode has a thickness of about 0.001 μm to about 5 μm, or about 0.1 μm to about 1 μm.

The electrode pairs may, in some embodiments, be preferentially aligned with the crystal lattice of the piezoelectric element. In some embodiments, the electrode pairs each include linear edges that are parallel and opposing (e.g., linear edge 420 of first electrode 410 and linear edge 425 of second electrode 415 are parallel and opposing as depicted in FIG. 4A), where the linear edges each form an angle of about 5° or less (or is generally parallel) with an axis in the crystal lattice of the piezoelectric element. For example, the piezoelectric element may be AT-cut quartz and the parallel, opposing linear edges of the electrodes may form an angle of about 5° or less (or are generally parallel) with the X-axis of the quartz crystal.

The electrodes in the vibration detection units can generally be composed of conductive materials. Non-limiting examples of suitable materials for the electrodes include gold, platinum, titanium, chromium, aluminum, nickel, a nickel alloy, silver, carbon, carbon nanotubes, polypyrrole, polyaniline, polythiophene, indium tin oxide, aluminum zinc oxide, gallium zinc oxide, and indium zinc oxide. These materials can be used alone or in combination. In some embodiments, each of the electrodes in the chemical sensor array includes the same conductive material. For example, the chemical sensor array may include four vibration detection units, each having two electrodes (eight total electrodes). The eight electrodes may each include, for example, gold. In some embodiments, the electrodes can include different conductive materials.

The conductive layer can be disposed on a side of the piezoelectric element opposite the electrodes in each vibration detection unit (e.g., conductive layer 170 is on a side of piezoelectric element 138 opposite first electrode 130 and second electrode 130). Without being bound to any particular theory, it is believe that the conductive layer serves as a film for sensing the analyte. The conductive film can generally have any shape, such as a square, circle, polygon, ellipse, and the like. In some embodiments, the conductive layer may be at or near the center of the top surface of the piezoelectric element.

In some embodiments, the conductive layer has a thickness of about 0.001 μm to about 5 μm, or about 0.1 μm to about 1 μm. The thickness of each conductive layer in the chemical sensor array may vary. In some embodiments, a first conductive layer in a first vibration detection unit in a chemical sensor array has a different thickness than a second conductive layer in a second vibration detection unit in the chemical sensor array. In some embodiments, each of the conductive layers in the chemical sensor array can have a different (or unique) thickness. For example, a chemical sensor array may have four vibration detection units. The thickness for the four conductive layers may be 0.2 μm, 0.4 μm, 0.6 μm, and 0.8 μm, respectively. Without being bound to any particular theory, it is believe that that different thicknesses result in different vibrational resonance frequencies for the piezoelectric elements. This may reduce interference between the piezoelectric elements that are fixed to the same substrate.

In some embodiments, the conductive layer has a width (e.g., diameter of a circular conductive layer) of about 0.1 mm to about 1 cm, or about 0.5 mm to about 2.5 mm. Similar to the thickness of the conductive layer, the width can be the same or different for each conductive layer in the chemical sensor array.

Various conducting materials can be used to form the conductive layer. Non-limiting examples of suitable material include gold, platinum, titanium, chromium, aluminum, nickel, a nickel alloy, silver, carbon, carbon nanotubes, polypyrrole, polyaniline, polythiophene, indium tin oxide, aluminum zinc oxide, gallium zinc oxide, or indium zinc oxide. These materials can be used alone or in combination. Each of the conductive layers in the chemical sensor array may include the same or different materials. For example, a chemical sensor array may include four conductive layers that are each gold, or alternatively, four conductive layers that are gold, platinum, indium tin oxide, and aluminum, respectively.

The conductive layer may optionally include an absorbing material configured to selectively absorb an analyte. The absorbing material may, for example, be applied to the surface of the conductive layer. Without being bound to any particular theory, the absorbing material may aid detecting the analyte because the increased absorption of a specific analyte can increase changes to vibrational resonance frequencies of the piezoelectric element. The absorbing material will vary depending upon the analyte of interest, and may be, for example, a polymer, ceramic, or a biomolecule (e.g., a protein). In some embodiments, each conductive layer in the chemical sensor includes a different absorbing material or is free of an absorbing material.

In some embodiments, at least one vibration detection unit includes a conductive layer having zirconium phosphate. In some embodiments, at least one vibration detection unit includes a conductive layer having an acrylic resin. In some embodiments, at least one vibration detection unit includes a conductive layer having polystyrene sulfonate. Zirconium phosphate, acrylic resins, and polystyrene sulfonate may each be used (either alone or combined), for example, to selectively absorb ammonia. In some embodiments, at least one vibration detection unit includes a conductive layer having an imine resin (e.g., polyethylimine) Imine resin may be used, for example, to selectively absorb methyl mercaptan. In some embodiments, at least vibration detection unit includes a conductive layer having propylene butyl. Propylene butyl may, for example, selectively absorb toluene. In some embodiments, at least one vibration detection unit includes a conductive layer having a methyl methacrylate (e.g., polymethylmethacrylate). Methyl methacrylates may, for example, selectively absorb acetone.

As a specific, non-limiting example, the chemical sensor array can include four vibration detection units that are together configured to detect ammonia in a gas. The first vibration detection unit may not include a material configured to selectively absorb an analyte, and therefore serves as a control. The second vibration detection has a conductive layer that includes zirconium phosphate. The third vibration detection has a conductive layer that includes an acrylic resin. The fourth vibration detection has a conductive layer that includes a polystyrene sulfonate. Oscillatory electrical signals receives from the electrodes on each vibration detection unit may be together correlated with an amount of ammonia in a fluid contacting the conductive layers.

As another specific, non-limiting example, the chemical sensor array can include at least eight vibration detection units. A different material configured to selectively absorb a different analyte can be included in each conductive layer: (i) no selective material (control), (ii) ammonia detection, (iii) acetone detection, (iv) hydrogen detection, (v) methane detection, (vi) methyl mercaptan detection, (vii) isoprene detection, and (viii) carbon monoxide. The chemical sensor array may be used, for example, to analyze the breath of a mammal (e.g., human). The contents of the various analytes (e.g., acetone) may indicate a possible health disorder in the mammal (e.g., diabetes).

The substrate for the chemical sensor array is not particularly limited. The substrate can be, for example, a printed wiring board, a ceramic substrate, a plastic substrate, and the like. The vibration detection units can be fixed to the substrate using, in some embodiments, an appropriate adhesive, such as silicon resin. The vibration detection units can be configured so that the conductive layer can be contacted to a fluid, while the electrodes are maintained separated from the fluid. For example, the conductive layer may be exposed through an opening in the substrate so that fluids can be applied to a side of the substrate opposite the electrode.

The substrate may, in some embodiments, be integral with each of the piezoelectric elements in the chemical sensor array. As will be discussed further below, the piezoelectric element may be formed by etching a piezoelectric material. Thus, in some embodiments, the substrate can include a piezoelectric material that is the same as the piezoelectric material in the piezoelectric elements. For example, the substrate can include lithium niobate, potassium niobate, lead zirconate titanate, barium titanate, langasite, or quartz. As a specific example, the substrate and piezoelectric elements may both be AT-cut quartz.

The number of vibration detection units in the chemical sensor array is not limited, and can be selected based on several factors, such as the number of analytes for detection and desired precision. The number of vibration detection units in the chemical sensor array can be, for example, at least two, at least four, at least eight, at least sixteen, or at least thirty-two. In some embodiments, the number of vibration detection units in the chemical sensor is 2 to 100, or 4 to 64.

The vibration detection units may be arranged in a pattern on the substrate. In some embodiments, the vibration detection units may be arranged in a two-dimensional lattice. Non-limiting examples of lattices that may be formed by the structures include a rhombic lattice, a hexagonal lattice, a square lattice, a rectangular lattice, or a parrallelogrammic lattice.

The chemical sensor array may optionally include a heating element that is thermally coupled to the conductive layers in the chemical sensor array. The heating element may be used to desorb any analytes absorbed in the conductive layers during use. Thus, the heating element may be used to prepare the chemical sensor array for repeated use.

Some embodiments disclosed herein include a method for sensing one or more analytes in a sample. The method may, in some embodiments, utilize any of the chemical sensor arrays disclosed in the present application.

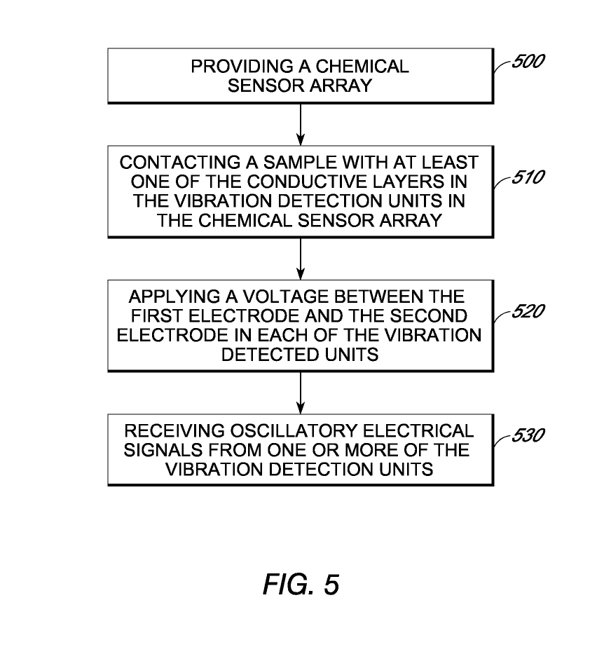

FIG. 5 is a flow diagram illustrating an example method for sensing one or more analytes in a sample that is within the scope of the present application. As illustrated in FIG. 5, the method may include one or more functions, operations, or actions: “Providing a chemical sensor array”, as illustrated in operation 500; “Contacting a sample with at least one of the conductive layers in the vibration detection units in the chemical sensor array”, as illustrated in operation 510; “Applying a voltage between the first electrode and the second electrode in each of the vibration detection units”, as illustrated in operation 520; and “Receiving oscillatory electrical signals from one or more of the vibration detection units”, as illustrated in operation 530. Although the method is illustrated as performing the operations sequentially, it will be appreciated that some operations may also be performed at about the same time.

At operation 500 “Providing a chemical sensor array”, a suitable chemical sensor array is provided for sensing an analyte. The chemical sensor array may, for example, be any of the chemical sensor arrays disclosed in the present application. In some embodiments, the chemical sensor array includes two or more vibration detection units. In some embodiments, each of the vibration detection units include: a piezoelectric element having a first side and a second side; a first electrode disposed on the first side of the piezoelectric element; a second electrode disposed on the first side of the piezoelectric element, wherein the second electrode is spaced apart from the first electrode; and a conductive layer disposed on the piezoelectric element, wherein the conductive layer is spaced apart from the first electrode and the second electrode.

At operation 510 “Contacting a sample with at least one of the conductive layers in the vibration detection units in the chemical sensor array”, a sample is contacted with the chemical sensor array so that an analyte can be sensed. The sample is not particularly limited, and may be, for example, a liquid or a gas. In some embodiments, the sample is the breath gas from a mammal, such as a human.

At operation 520 “Applying a voltage between the first electrode and the second electrode in each of the vibration detection units”, a voltage can be applied to the electrodes that causes the piezoelectric element to vibrate. The applied voltage is not particularly limited, and can be sufficient to impart a vibrational resonance in the piezoelectric element. The voltage can be applied, for example, by electrically coupling the electrodes to a voltage source.

At operation 530 “Receiving oscillatory electrical signals from one or more of the vibration detection units”, an oscillatory electrical signal corresponding to the vibrational resonance frequency of the piezoelectric element can be received. The signal may be received, for example, by a data acquisition unit electrically coupled to the electrodes. The received electrical signals may optionally be used to determine one or more frequencies associated with signals. For example, a fourier transform can be performed to identify frequencies of the electrical signals received from the vibration detection. Techniques for performing fourier transforms are well-known in the art and include Fast Fourier Transforms (FFT). The frequencies may then be correlated with an amount of an analyte in the sample. For example, an increased amount of an analyte may decrease the frequency, and therefore the decrease in frequency may be correlated with amount of analyte. This may be achieved, for example, using a look-up table that includes the amount of analyte based on one or more frequencies, or an empirical formula for calculating the amount of analyte based on one or more frequencies.

Non-limiting examples of analytes that may be sensed using the methods disclosed herein include ammonia, acetone, hydrogen, methane, methyl mercaptan, ethane, isoprene, carbon monoxide, acetaldehyde, or toluene. The method may, in some embodiments, include detecting two or more of these analytes in the same sample at about the same time.

Some embodiments disclosed herein include a method for making a chemical sensory array. The method may, in some embodiments, be used to prepare any of the chemical sensor arrays disclosed in the present application.

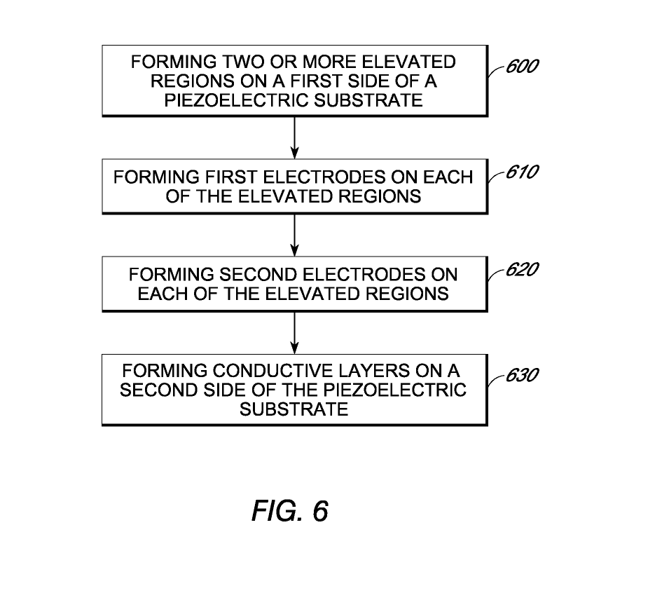

FIG. 6 is a flow diagram illustrating an example method for making a chemical sensor array that is within the scope of the present application. As illustrated in FIG. 6, the method may include one or more functions, operations, or actions: “Forming two or more elevated regions on a first side of a piezoelectric substrate”, as illustrated in operation 600; “Forming first electrodes on each of the elevated regions”, as illustrated in operation 610; “Forming second electrodes on each of the elevated regions”, as illustrated in operation 620; and “Forming conductive layers on a second side of the piezoelectric substrate”, as illustrated in operation 630. Although the method is illustrated as performing the operations sequentially, it will be appreciated that some of the operations may also be performed in a different order or at about the same time.

At operation 600 “Forming two or more elevated regions on a first side of a piezoelectric substrate”, piezoelectric elements can be formed into a piezoelectric substrate. Thus, the elevated regions can be formed into various shapes, such as convex, trapezoidal, square, and cylindrical (e.g., the various shapes for the piezoelectric element depicted in FIGS. 1-3).

The piezoelectric substrate can generally include any of the piezoelectric materials discussed above with regard to the piezoelectric elements. For example, the piezoelectric substrate can include AT-cut quartz. The substrate can have a thickness of, for example, 0.1 μm to about 1 mm.

The elevated regions may, in some embodiments, be formed by etching the piezoelectric substrate. As an example, a photoresist pattern can formed on the first side of piezoelectric substrate and then the substrate can be etched to form the elevated regions. The structure of the elevated regions may correspond to the pattern of the photoresist. The photoresist can be removed using standard procedures after etching. In some embodiments, the etching includes reactive ion etching.

At operation 610 “Forming first electrodes on each of the elevated regions”, the first electrodes can be formed on the elevated regions. The electrodes can be formed on the elevated regions using standard techniques. Non-limiting examples of techniques for the forming the first electrode include physical vapor deposition, chemical vapor deposition, sputtering, screen printing, ink jet printing, or electrospray deposition.

At operation 620 “Forming second electrodes on each of the elevated regions”, the second electrodes can be formed on the elevated regions. The electrodes can be formed on the elevated regions using any of the techniques described above with regard to the first electrodes. In some embodiments, the first electrodes and the second electrodes are formed at about the same time.

At operation 630 “Forming conductive layers on a second side of the piezoelectric substrate”, a conductive layer can be formed on a side of the piezoelectric substrate opposite the elevated regions. In some embodiments, the conductive layers are formed to be laterally aligned with the elevated regions. The conductive layer can also be formed using standard techniques. Non-limiting examples of techniques for the forming the conductive layer include physical vapor deposition, chemical vapor deposition, sputtering, screen printing, ink jet printing, or electrospray deposition.

The method may also optionally include applying an absorbing material to the conductive layer. The resulting conductive layer may therefore be configured to selectively absorb an analyte. The absorbing layer may be applied, for example, using sputtering, screen printing, and the like. As an example, an acrylic resin can be applied to a conductive layer by spin coating to obtain a conductive layer that selectively absorbs ammonia.

Some embodiments disclosed herein include a system for sensing an analyte in a sample. The system can include any of the chemical sensor arrays disclosed in the present application. Thus, for example, the chemical sensor array can include two or more vibration detection units each having a piezoelectric element, a first electrode, a second electrode and a conductive layer.

The system may also include one or more voltage sources electrically coupled to the first electrode and the second electrodes. The voltage source can be configured to apply a voltage effective to produce vibrational resonance in the piezoelectric element.

The system may also include, in some embodiments, one or more data acquisition units electrically coupled to the first electrodes and the second electrodes. The data acquisition units can be configured to receive oscillatory signals from the first electrode and the second electrode. The oscillatory signals may correspond to the vibrational resonance frequency of the piezoelectric element.

In some embodiments, the system for sensing an analyte includes a processor. The processor can be configured to receive a signal from the data acquisition unit representing the oscillatory signal. As an example, the signal may be digital and provide the voltage level obtained from the vibration detection unit at regular intervals. In some embodiments, the process can be configured to determine a frequency of the oscillatory signals. For example, the processor may apply a Fourier transform (e.g., using the Fast Fourier Transform algorithm) to the data received from the data acquisition unit to determine the frequency.

The processor may also be configured to correlate the one or more determined frequencies with an amount of an analyte in the sample. The processor may correlate the amount of analyte using a look-up table in memory that provides an amount of analyte based on the one or more measured frequencies. The processor may, either alone or combined with the look-up table, apply an empirical formula to determine an amount of analyte in the sample based on the one or more frequencies.

The processor may, in some embodiments, be in communication with the voltage source. In some embodiments, the processor may send a signal to the voltage source indicating to apply a voltage to one or more electrode pairs in the chemical sensor array. In some embodiments, the processor may send a signal to the data acquisition unit to begin sending a signal representing the oscillatory signal from the electrode pairs. The processor may therefore synchronize applying a voltage to the piezoelectric element and subsequently (or at about the same time) receiving data from the data acquisition unit.

The processor can be any type of a microprocessor (μP), a microcontroller (μC), a digital signal processor (DSP), or any combination thereof. The process may be in communication with a memory source, such as any type of volatile memory (such as RAM), non-volatile memory (such as ROM, flash memory, etc.), or any combination thereof. The memory may store instructions for performing any of the methods disclosed herein.

The skilled artisan, guided by the teachings of the present application, will appreciate that various components of the system can be integrated into a single device. For example, the voltage source and data acquisition unit may be integrated into a single device. As another example, the voltage source, data acquisition unit, and processor may be integrated into a single device.

The system may be configured to sense one or more analytes. Non-limiting examples of analytes include ammonia, acetone, hydrogen, methane, methyl mercaptan, ethane, isoprene, carbon monoxide, acetaldehyde, or toluene. The sample may be a fluid, such as a liquid or a gas. In some embodiments, the sample is a breath gas.

The systems and methods described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium can be, for example, coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

With respect to the use of substantially any plural and/or singular terms herein, those having skill in the art can translate from the plural to the singular and/or from the singular to volume of wastewater can be received in the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

### EXAMPLES

Additional embodiments are disclosed in further detail in the following examples, which are not in any way intended to limit the scope of the claims.

### Example 1

### Vibrational Analysis of Quartz Resonators

Quartz resonators were modeled using FEMTET from Murata Software by FEM piezoelectric analysis. A convention quartz crystal microbalance was modeled as having a 2 mm×2 mm×0.1 mm AT-cut quartz substrate with two circular electrodes (1 mm diameter) on opposite sides of the substrate. A second quartz crystal microbalance was modeled with same dimensions for the AT-cut quartz substrate. However, two semi-circular circular electrodes were placed on the same side of the substrate same configuration as shown in FIG. 4A. Each electrode had a 0.4 mm radius, while the linear edges were parallel to the X-axis of the quartz and spaced 0.2 mm apart. The second quartz crystal microbalance also included a circular conductive layer (1 mm diameter) on the side of the substrate opposite the electrodes. The vibrations in the substrates were calculated when driven at a resonant frequency of 17.7 MHz.

The results demonstrated that leakage vibration is lower for the second quartz crystal microbalance having the electrodes on the same side of the substrate and a conductive layer on the opposite side. Thus, it is expected that the effects between other resonators on the same piezoelectric substrate should be less when the electrode are on the same side and a conductive layer is on the opposite side.

### Example 2

### Electrode Configuration

Different electrode configurations were tested using a piezoelectric element having AT-cut quartz crystal with a 100 μm thickness. A pair of semi-circular electrodes was formed on a piezoelectric element and the spacing between the linear edges of the electrodes was varied. The electrode pairs were also tested having the linear edges either parallel or perpendicular to the X-axis of the quartz crystal. The conductance was measured using an impedance analyzer (Impedance Analyzer E 4994A from Agilent) with a bias voltage of 0.5 V. The results are summarized in the table below:

| | Orientation of | Gap between | |
|---|---|---|---|
| | Linear Edge to | Electrodes | Conductance |
| Sample | X-axis | (μm) | (mS) |
| 1 | Parallel | 50 | 13 |
| 2 | Parallel | 80 | 18 |
| 3 | Parallel | 143 | 17 |
| 4 | Parallel | 175 | 18 |
| 5 | Parallel | 270 | 14 |
| 6 | Perpendicular | 80 | 7 |
| 7 | Perpendicular | 143 | 13 |
| 8 | Perpendicular | 175 | 12 |
| 9 | Perpendicular | 270 | 11 |

The results show the gap between the electrodes provides superior conductance at about 1 to about 2.5 times the thickness of the piezoelectric element.

### Example 3

### Measuring Ammonia Gas

A first chemical sensor was fabricated by reactive ion etching of an AT-cut quartz substrate having a thickness of 100 μm. The resulting piezoelectric element had a convex surface of about 4 μm. Two semi-circular electrodes (2 mm diameter) were formed on the piezoelectric element having 200 μm spacing between the linear edges of the electrodes. A conductive layer a 2 mm diameter was formed on the planar surface of the piezoelectric element opposite the convex surface. The chemical sensor had a resonant frequency of about 16.8 MHz and a mechanical Q factor in the gas phase of about 55,000.

A second chemical sensor was fabricated in the same manner as the first chemical sensor. Additionally, maleic anhydride-grafted polypropylene (UMEX 1010 (Sanyo Chemical Industries Ltd.)) was applied to the conductive layer to form an ammonia-absorbing layer. Kapton tape was used to mask the planar surface of the piezoelectric element and the polymer was applied by spin coating. The polymer was dissolved in xylene and applied for 30 seconds at 5000 RPM. The Kapton tape was then removed and the polymer coating dried for 15 minutes on a hot plate at 120° C. The coated chemical sensor was left in ammonia gas for 30 minutes and then air for about two hours before using.

A commercially available chemical sensor having a pair of electrodes (5 mm diameter) on opposite sides of an AT-cut quartz crystal (180 μm thickness) was used for comparison. The chemical sensor was coated on one electrode with UMEX 1010 by spin coating for 30 seconds at 4000 RPM and then dried 15 minutes on a hot plate at 120° C. The coated conventional chemical sensor was left in ammonia gas for 30 minutes and then air for about two hours before using.

Each of the chemical sensors was placed in a vessel and 25 ppm of ammonia gas was introduced into the vessel. The absolute concentration of ammonia gas was measured using a GASTEC detector tube for ammonia (product code: 3L ammonia) and the ammonia concentration in the vessel was adjusted. The electrodes in each chemical sensory were connected to oscillators to cause oscillation and changes in their frequencies were measured using AGILENT frequency counters (53131A 225 MHz universal counter from AGILENT).

For the commercially available chemical sensor coated with UMEX 1010, ammonia gas was gradually introduced. After 102 minutes, the vessel was presumed to reach saturation, and the vessel was opened to air. The change in frequency for the commercially available chemical sensor was about −140 Hz. The frequency measurements during testing showed fluctuations of about 1 Hz, and therefore the resolution was estimated to be about 1 Hz.

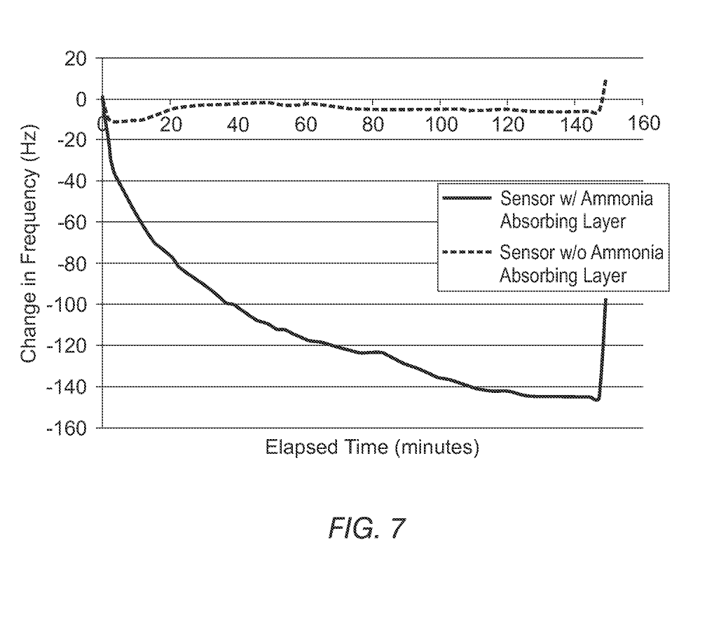

Both the first chemical sensor and the second chemical sensor were gradually exposed to ammonia gas. After 147 minutes, the vessel was presumed to reach saturation, and the vessel was opened to air. The change in frequency for the commercially available chemical sensor is shown in FIG. 7. The frequency measurements during testing showed fluctuations of about 0.2 Hz, and therefore the resolution was estimated to be about 0.2 Hz.

These results demonstrate that the coated chemical sensor with electrodes on the same side have about the same sensitivity as the coated, commercially available sensor (about 140 Hz change at saturation) despite using a much smaller electrode (2 mm compared to 5 mm). Moreover, the chemical sensor with electrodes on the same side had superior resolution (about 0.2 Hz v. about 1 Hz).

1. A chemical sensor array comprising two or more vibration detection units fixed to a substrate, wherein the vibration detection units each independently comprise:
a piezoelectric element having a first side and a second side;
a first electrode disposed on the first side of the piezoelectric element;
a second electrode disposed on the first side of the piezoelectric element, wherein the second electrode is spaced apart from the first electrode; and
a conductive layer disposed on the piezoelectric element, wherein the conductive layer is spaced apart from the first electrode and the second electrode.

2. The chemical sensor array of claim 1, wherein the chemical sensor array has a largest dimension of less than or equal to about 2 cm.

3. The chemical sensor array of claim 1, wherein the piezoelectric element has a trapezoidal shape.

4. The chemical sensor array of claim 1, wherein the first side of the piezoelectric element has a convex surface.

5. The chemical sensor array of claim 1, wherein the second side of the piezoelectric element has a planar surface.

6. The chemical sensor array of claim 1, wherein the piezoelectric element has a thickness of about 10 μm to about 500 μm.

7. The chemical sensor array of claim 1, wherein a distance between the first electrode and the second electrode is about 1 to about 3 times the thickness of the piezoelectric element.

8. (canceled)

9. The chemical sensor array of claim 1, wherein the piezoelectric element comprises a ceramic.

10. (canceled)

11. (canceled)

12. The chemical sensor array of claim 11, wherein a line extending approximately equidistant between the first electrode and the second electrode forms an angle of less than about 5° with the X-axis of the quartz.

13. The chemical sensor array of claim 1, wherein the conductive layer is disposed on the second side of the piezoelectric element.

14. The chemical sensor array of claim 1, wherein the conductive layer comprises one or more of gold, platinum, titanium, chromium, aluminum, nickel, a nickel alloy, silver, carbon, carbon nanotubes, polypyrrole, polyaniline, polythiophene, indium tin oxide, aluminum zinc oxide, gallium zinc oxide, or indium zinc oxide.

15. (canceled)

16. (canceled)

17. The chemical sensor array of claim 1, the first electrode and the second electrode each independently comprise one or more of gold, platinum, titanium, chromium, aluminum, nickel, a nickel alloy, silver, carbon, carbon nanotubes, polypyrrole, polyaniline, polythiophene, indium tin oxide, aluminum zinc oxide, gallium zinc oxide, or indium zinc oxide.

18. (canceled)

19. (canceled)

20. The chemical sensor array of claim 1, wherein one or more of the conductive layers in the vibration detection units further comprise an absorbing material configured to selectively absorb an analyte.

21. The chemical sensor array of claim 20, wherein the absorbing material is applied to a surface of the conductive layers.

22. The chemical sensor array of claim 20, wherein the conductive layers in each of the vibration detection units comprise a different absorbing material.

23. The chemical sensor array of claim 1, wherein the substrate is integral with the piezoelectric elements in each of the vibration detection units.

24. The chemical sensor array of claim 1, further comprising a heating element thermally coupled to the conductive layers in the vibration detection units.

25. A method for sensing one or more analytes in a sample, the method comprising:
providing a chemical sensor array comprising two or more vibration detection units, wherein the vibration detection units each comprise:
a piezoelectric element having a first side and a second side;
a first electrode disposed on the first side of the piezoelectric element;
a second electrode disposed on the first side of the piezoelectric element, wherein the second electrode is spaced apart from the first electrode; and
a conductive layer disposed on the piezoelectric element, wherein the conductive layer is spaced apart from the first electrode and the second electrode;
contacting the sample with at least one of the conductive layers in the vibration detection units;
applying a voltage between the first electrode and the second electrode in each of the vibration detection units; and
receiving oscillating electrical signals from one or more of the vibration detection units using the first electrode and the second electrode.

26. The method of claim 25, further comprising determining one or more frequencies for the oscillating electrical signals.

27. The method of claim 26, further comprising correlating the frequencies from the vibration detection units with an amount of the analytes.

28. (canceled)

29. (canceled)

30. A method for making a chemical sensor array, the method comprising:
forming two or more elevated regions on a first side of a piezoelectric substrate;
forming first electrodes on each of the elevated regions;
forming second electrodes on each of the elevated regions; and
forming conductive layers on a second side of the piezoelectric substrate, wherein each of the conductive layers are laterally aligned with one of the elevated regions.

31. The method of claim 30, wherein the forming two or more elevated regions on a first side of a piezoelectric substrate comprises:
forming a photoresist pattern on the first side of the piezoelectric substrate; and
etching the piezoelectric substrate to form the elevated regions of the first side of the piezoelectric substrate.

32. The method of claim 31, wherein etching the piezoelectric substrate to form the elevated regions of the first side of the piezoelectric substrate comprises reactive ion etching.

33. (canceled)

34. The method of claim 30, further comprising applying an absorbing material to the conductive layer, wherein the conductive layer is configured to selectively absorb an analyte.

35. A system for sensing an analyte in sample, the system comprising:
a chemical sensor array comprising two or more vibration detection units, wherein the vibration detection units each comprise:
a piezoelectric element having a first side and a second side;
a first electrode disposed on the first side of the piezoelectric element;
a second electrode disposed on the first side of the piezoelectric element, wherein the second electrode is spaced apart from the first electrode; and
a conductive layer disposed on the piezoelectric element, wherein the conductive layer is spaced apart from the first electrode and the second electrode;
one or more voltage sources electrically coupled to the first electrode and the second electrode in each of the vibration detection units;
one or more data acquisition units electrically coupled to the first electrode and the second electrode in the vibration detection units, wherein the data acquisition units are configured to receive oscillator signals from the first electrode and the second electrode; and
a processor configured to receive a signal representing the oscillator signals from the data acquisition units, wherein the processor is further configured to determine a frequency for the oscillator signals.

36. The system of claim 35, wherein the first side of the piezoelectric element has a convex surface.
